(19) United States
(12) Patent Application Publication
(10) Pub. No.: US 2024/0408786 A1
(43) Pub. Date: Dec. 12, 2024

(54) METHOD FOR MILLING COUPLING PARTS TO A DECORATIVE PANEL

(71) Applicant: UNILIN, BV, Wielsbeke (BE)

(72) Inventor: Jan DE RICK, Geraardsbergen (BE)

(21) Appl. No.: 18/700,322

(22) PCT Filed: Oct. 10, 2022
(86) PCT No.: PCT/IB2022/059678

§ 371 Date: Apr. 11, 2024

(30) Foreign Application Priority Data
Oct. 22, 2021 (BE) 2021/5831

(51) Int. Cl. B27F 1/06; E04F 15/02; E04F 15/10

(52) U.S. Cl. CPC B27F 1/06; E04F 15/02038; E04F 15/107; E04F 2201/0153; E04F 2201/023; E04F 2201/042; E04F 2201/043

(57) ABSTRACT

A method includes the milling of coupling parts on a pair of opposite edges of a decorative panel. These coupling parts are configured for coupling said panels on their opposite edges. The coupling parts may comprise locking parts for locking the coupled panels. The opposite edges comprise sealing faces, which in the coupled state are in contact or abut closely to each other. In a first milling operation, material is milled away to form a rough shape of the coupling part. In a second milling operation, the sealing face acquires its final form and dimension, wherein in the second milling operation, everywhere perpendicular to the final first sealing face, at most 0.3 mm of material is milled away.

The present invention relates to a method for milling coupling parts to a decorative panel.

WO97/47834A1 presents a method for milling coupling parts to a decorative panel. On a continuous milling machine, the coupling parts are milled in successive steps on both sides of the panel. In this process, the panel is led with its decorative side downwards. Milling is carried out simultaneously on the two opposite edges of the rectangular panel. The milling cutters are thereby mounted opposite each other.

The method according to the prior art for milling coupling parts on decorative panels has the drawback that in the case of delicate panels the coupling parts cannot be milled with the desired correction. More specifically, coupling parts cannot be milled with the desired correction in the case of panels that comprise an elastic sound-absorbing layer on the side with the decorative layer. If the coupling parts cannot be made with the desired close tolerances, the panels cannot be installed correctly.

Thus, the aim of the invention is to present methods that ensure that coupling parts can be milled with the required accuracy, also and especially in the case of delicate panels; for example, with panels that comprise a flexible sound-absorbing layer with low density on the decorative side of the panel. This must allow panels to be installed correctly, for example in a floor covering.

Therefore the first aspect of the invention relates to a method for milling, on a continuous milling machine, coupling parts on a pair of opposite edges of a decorative panel; wherein the panel comprises a substrate and a decorative layer; wherein the panel has a decorative side, which is the side of the panel where the decorative layer is located; and an underside, which is the side of the panel opposite the decorative layer; wherein the pair of opposite edges comprises a first edge and an opposite second edge; wherein the coupling parts are configured for coupling together the first edge of such a panel to the second edge of another such panel; preferably wherein the coupling parts comprise locking parts for locking such a panel coupled with its first edge to the second edge of another such panel in the direction perpendicular to the plane of the coupled panels and/or in the direction perpendicular to the coupled edges and in the plane of the panels; wherein the method is carried out so that a coupling part in the form of a tongue is milled on the first edge and a coupling part in the form of a groove is milled on the second edge, wherein the groove is delimited by a lower lip and an upper lip; wherein the upper lip is on the decorative side; wherein on the decorative side, the panel comprises a first sealing face on the first edge, wherein the distal end of the upper lip comprises a second sealing face, wherein the first sealing face and the second sealing face are configured so that in the coupled state of such a panel with its first edge against the second edge of another such panel, the first sealing face of said panel comes into contact with or abuts closely to the second sealing face of the other such panel. The method comprises the step in which, in a first tongue edge milling operation, material of the panel is milled away on the first edge on the decorative side where the tongue will be formed. Preferably, in this first tongue edge milling operation, on the decorative side a rough shape is formed of at least one part of the tongue to be milled in the method. The method comprises the step in which, in a second tongue edge milling operation, the first sealing face acquires its final form and dimension. The method is characterized in that, in the second tongue edge milling operation, everywhere perpendicular to the final first sealing face, at most 0.3 mm of material is milled away; and preferably at most 0.2 mm.

The first tongue edge milling operation allows an amount of material to be milled away on the first edge without the final form and dimension of the first sealing face being established. In a successive second tongue edge milling operation, the first sealing face acquires its final dimension and form. In the case of delicate panels, particularly with panels that comprise a flexible layer above the substrate and underneath the decorative finish, there is a risk, owing to the compressive forces perpendicular to the first edge during milling, of a displacement occurring in the panel. This would mean that the first sealing face would not be milled with the required close tolerance. In order to avoid this, in the second tongue edge milling operation, which establishes the final form and dimension of the first sealing face, only a limited amount of material is removed. As a result, in this second tongue edge milling operation the compressive forces perpendicular to the first edge remain limited, and the first sealing face can be milled with the required close tolerance.

In the second tongue edge milling operation, material is removed at places on the first edge where material had already been milled away in the first tongue edge milling operation.

In a preferred embodiment, the method of the first aspect of the invention is characterized in that the method comprises the step in which, in a third tongue edge milling operation, the side of the tongue directed towards the decorative side acquires its final form and dimension, wherein in the third tongue edge milling operation where the tongue, in the third tongue edge milling operation, acquires its final form and dimension on the side directed towards the decorative side, everywhere locally perpendicular to this final dimension of the tongue, at most 0.3 mm of material is milled away, and preferably at most 0.2 mm.

This embodiment allows the coupling parts on the first edge to be produced to close tolerances, and specifically the side of the tongue directed towards the decorative side. This can be achieved because in the third milled edge milling operation, the compressive forces perpendicular to the first edge due to milling are limited. This limits the possible displacement of the layers in the panel.

More preferably, the method is characterized in that, in the third tongue edge milling operation, the tongue on the underside of the panel at least over a distal part of the tongue acquires its final form and dimension, wherein, where the tongue acquires its final form and dimension in the third tongue edge milling operation on the underside of the panel, everywhere in the third tongue edge milling operation, in the direction locally perpendicular to this final dimension of the tongue, at most 0.3 mm of material is milled away, and preferably at most 0.2 mm.

This embodiment makes it possible to ensure synergistically that the coupling parts on the first edge can be produced to close tolerances. As a result, panels can be installed correctly.

A preferred embodiment of the first aspect of the invention is characterized in that, in a fourth tongue edge milling operation, carried out at least before the third tongue edge milling operation, and preferably before the first tongue edge milling operation, material is milled away on the underside on the first edge; preferably wherein a rough shape is formed on the underside of the panel of at least one distal end of the tongue.

These milling operations, which do not yet provide the final forms and dimensions, allow a rough shape to be created, after which, in subsequent milling operations in which only a small amount of material is removed, the final form and dimension of segments of the coupling part are produced on the first edge with the desired close tolerances.

A preferred embodiment of the first aspect of the invention is characterized in that, in a fifth tongue edge milling operation, a recess is milled on the underside of the tongue, wherein the recess is configured to interact with a projection on the lower lip for locking, in the plane of the decorative panels and perpendicular to the coupled edges, a decorative panel of this kind coupled with its first edge to the second edge of another such decorative panel.

This embodiment allows the locking parts in the coupling parts to be milled correctly, which are to provide the locking of coupled panels on their first pair of opposite edges in the direction perpendicular to the coupled edges and in the plane of the panels.

A preferred embodiment of the first aspect of the invention is characterized in that the first tongue edge milling operation and/or the second tongue edge milling operation are carried out progressively in the direction of advance of the panels through the continuous milling machine.

This embodiment ensures synergistically that the first sealing face can be produced to close tolerances, because in this way the compressive force perpendicular to the milled edge and in the plane of the panels in the milling operations is limited.

A preferred embodiment of the first aspect of the invention is characterized in that, in the second tongue edge milling operation, a pressure shoe presses on the panel, wherein the pressure of the pressure shoe is at most 0.8 bar.

This embodiment ensures synergistically that the first sealing face can be milled correctly. If the panel comprises an elastic or flexible layer close to the decorative side, a high pressure of the pressure shoe in the milling operation may cause an indentation of the panel perpendicular to the panel. Said indentation may lead to incorrect milling of the first sealing face.

A preferred embodiment of the first aspect of the invention is characterized in that, in the first tongue edge milling operation, a pressure shoe presses on the panel, wherein the pressure of the pressure shoe is at most 0.8 bar.

This embodiment offers the advantage that the coupling parts can be milled more accurately.

A preferred embodiment of the first aspect of the invention is characterized in that the first tongue edge milling operation is carried out in at least two milling steps.

Therefore the amount of material that is removed per milling operation is limited. This makes it possible to limit the pressure perpendicular to the milled edge, so that milling is more accurate.

A preferred embodiment of the first aspect of the invention is characterized in that the fourth tongue edge milling operation is carried out in at least two milling steps.

Therefore the amount of material that is removed per milling operation is limited. This makes it possible to limit the pressure perpendicular to the milled edge, so that milling is more accurate.

The second aspect of the invention relates to a method for milling, on a continuous milling machine, coupling parts on a pair of opposite edges of a decorative panel; optionally a method such as in any embodiment of the first aspect of the invention; wherein the panel comprises a substrate and a decorative layer; wherein the panel has a decorative side, which is the side of the panel where the decorative layer is located; and an underside, which is the side of the panel opposite the decorative layer; wherein the pair of opposite edges comprises a first edge and an opposite second edge; wherein the coupling parts are configured for coupling together the first edge of such a panel to the second edge of another such panel; preferably wherein the coupling parts comprise locking parts for locking such a panel coupled with its first edge to the second edge of another such panel in the direction perpendicular to the plane of the coupled panels and/or in the direction perpendicular to the coupled edges and in the plane of the panels; wherein the method is carried out so that a coupling part in the form of a tongue is milled on the first edge and a coupling part in the form of a groove is milled on the second edge, wherein the groove is delimited by a lower lip and an upper lip; wherein the upper lip is on the decorative side; wherein on the decorative side, the panel comprises a first sealing face on the first edge, wherein the distal end of the upper lip comprises a second sealing face, wherein the first sealing face and the second sealing face are configured so that in the coupled state of such a panel with its first edge against the second edge of another such panel, the first sealing face of said panel comes into contact with or abuts closely to the second sealing face of the other such panel. The method comprises the step in which, in a first groove edge milling operation, material of the panel is milled away on the second edge on the decorative side where the groove will be formed. Preferably, in this first groove edge milling operation, on the decorative side, a rough shape is formed of at least one part of the profile to be milled on the second edge in the method. The method comprises the step in which, in a second groove edge milling operation, the second sealing face acquires its final form and dimension. The method is characterized in that, in the second groove edge milling operation, everywhere perpendicular to the final second sealing face, at most 0.3 mm of material is milled away; and preferably at most 0.2 mm.

The first groove edge milling operation allows an amount of material on the second edge to be milled away without the final form and dimension of the second sealing face being established. In a subsequent second groove edge milling operation, the second sealing face acquires its final dimension and form. In the case of delicate panels, particularly with panels that comprise a flexible layer above the substrate and underneath the decorative finish, there is a risk, owing to the compressive forces perpendicular to the second edge during milling, of a displacement occurring in the panel. This would mean that the second sealing face would not be milled with the required close tolerance. To avoid this, in the second groove edge milling operation, which establishes the final form and dimension of the second sealing face, only a limited amount of material is removed. As a result, in this second groove edge milling operation, the compressive forces perpendicular to the second edge remain limited, and the second sealing face can be milled with the required close tolerance.

In the second groove edge milling operation, material is removed at places on the second edge where material had already been milled away in the first groove edge milling operation.

A preferred embodiment of the second aspect of the invention is characterized in that the method comprises the step in which, in a third groove edge milling operation, at least the part of the groove proximal to the upper lip is formed.

The groove has a small depth, measured perpendicular to the second edge, and the dimension of the groove perpendicular to the plane of the panel is limited. As a result, the compressive forces on the second edge during this third groove edge milling operation remain limited.

More preferably, in a fourth groove edge milling operation, carried out at least before the third milling operation, and preferably before the first groove edge milling operation, material is milled away on the second edge.

This embodiment ensures that it is possible to limit the amount of material that is removed in the third groove edge milling operation. This promotes accuracy in the third groove edge milling operation.

A preferred embodiment of the second aspect of the invention is characterized in that, in a fifth groove edge milling operation, at least a part of the upper side of the lower lip acquires its final form, preferably the distal end of the lower lip also acquires its final form in this fifth groove edge milling operation.

A preferred embodiment of the second aspect of the invention is characterized in that the first groove edge milling operation and/or the second groove edge milling operation are carried out progressively in the direction of advance of the panels through the continuous milling machine.

This embodiment ensures synergistically that the second sealing face can be produced to close tolerances, because in this way the compressive force perpendicular to the milled edge and in the plane of the panels in the milling operations is limited.

A preferred embodiment of the second aspect of the invention is characterized in that, in the second groove edge milling operation, a pressure shoe presses on the panel, wherein the pressure of the pressure shoe is at most 0.8 bar.

This embodiment ensures synergistically that the second sealing face can be milled correctly. If the panel comprises an elastic or flexible layer close to the decorative side, a high pressure of the pressure shoe in the milling operation may cause an indentation of the panel perpendicular to the panel. Such indentation may lead to incorrect milling of the second sealing face.

A preferred embodiment of the second aspect of the invention is characterized in that, in the first groove edge milling operation, a pressure shoe presses on the panel, wherein the pressure of the pressure shoe is at most 0.8 bar.

This embodiment offers the advantage that the coupling parts can be milled more accurately.

A preferred embodiment of the second aspect of the invention is characterized in that the first groove edge milling operation is carried out in at least two milling steps.

Therefore the amount of material that is removed per milling operation is limited. This makes it possible to limit the pressure perpendicular to the milled edge, so that milling is more accurate.

A preferred embodiment of the second aspect of the invention is characterized in that the fourth groove edge milling operation is carried out in at least two milling steps.

Therefore the amount of material that is removed per milling operation is limited. This makes it possible to limit the pressure perpendicular to the milled edge, so that milling is more accurate.

A preferred embodiment of a method both according to the first aspect of the invention and according to the second aspect of the invention is characterized in that the first tongue edge milling operation and the first groove edge milling operation are carried out simultaneously in the continuous milling machine and directly opposite each other relative to the panel.

A preferred embodiment of a method both according to the first aspect of the invention and according to the second aspect of the invention is characterized in that the second tongue edge milling operation and the second groove edge milling operation are carried out simultaneously in the continuous milling machine and directly opposite each other relative to the panel.

A preferred embodiment of a method both according to the first aspect of the invention and according to the second aspect of the invention is characterized in that the third tongue edge milling operation and the third groove edge milling operation are carried out simultaneously in the continuous milling machine and directly opposite each other relative to the panel.

A preferred embodiment of a method both according to the first aspect of the invention and according to the second aspect of the invention is characterized in that the fourth tongue edge milling operation and the fourth groove edge milling operation are carried out simultaneously in the continuous milling machine and directly opposite each other relative to the panel.

A preferred embodiment of a method both according to the first aspect of the invention and according to the second aspect of the invention is characterized in that the fifth tongue edge milling operation and the fifth groove edge milling operation are carried out simultaneously in the continuous milling machine and directly opposite each other relative to the panel.

The carrying out of milling operations simultaneously and directly opposite each other on the first edge and on the second edge allows forces exerted on the edges by the milling operations to be compensated, especially if these do not differ from each other too much and/or remain limited on both edges.

A preferred embodiment according to the first aspect and/or according to the second aspect of the invention is characterized in that the coupling parts are configured so that a panel can be coupled with its first edge to the second edge of another such panel by means of a rolling motion and/or by means of a sliding motion substantially parallel to the plane of the panels, wherein snapping occurs.

A preferred embodiment according to the first aspect of the invention and/or according to the second aspect of the invention is characterized in that the decorative panel comprises an intermediate layer and a top layer, wherein the top layer comprises the decorative layer, wherein the intermediate layer is located between the substrate and the top layer, wherein the intermediate layer is located over its entire thickness in the upper lip; wherein preferably the minimum thickness of the substrate in the upper lip and under the intermediate layer, in the section where, in the coupled state of a panel with its first edge against the second edge of another such panel, the tongue of the first panel comes into contact with the upper lip of the second panel, is at least 0.4 mm, and preferably is at least 0.5 mm and more preferably is at least 1 mm. Preferably this intermediate layer is a pliable, flexible layer.

The intermediate layer may ensure better sound-absorbing properties of the decorative panels, for example and especially if these are used as floor panels. This embodiment further ensures that the tongue and groove can be milled stably, to close tolerances; and that stable, good coupling of the panels is obtained during their installation.

The third aspect of the invention relates to a method for milling, on a continuous milling machine, coupling parts on a pair of opposite edges of a decorative panel; optionally a method such as in any embodiment of the first aspect and/or of the second aspect of the invention, wherein the panel comprises a substrate and a decorative layer, wherein the panel has a decorative side, which is the side of the panel where the decorative layer is located; and an underside, which is the side of the panel opposite the decorative layer, wherein the pair of opposite edges comprises a third edge and an opposite fourth edge, wherein in the method, a coupling part that comprises a downward directed upper hook-shaped portion is formed on the third edge, wherein the upper hook-shaped portion comprises a lip with a downward directed locking element that forms a male part; wherein in the method, a coupling part that comprises an upward directed lower hook-shaped portion is formed on the fourth edge, wherein the lower hook-shaped portion consists of a lip with an upward directed locking element that defines a female part in the form of a recess proximal thereto; wherein the coupling parts are configured for coupling together the third edge of such a panel to the fourth edge of another such panel; wherein on coupling the third edge of such a panel to the fourth edge of another such panel, the male part engages in the female part wherein locking is produced in the direction in the plane of the panels and perpendicular to the coupled edges; preferably wherein the coupling part on the third edge and the coupling part on the fourth edge comprise locking parts, so that on coupling the third edge of such a panel to the fourth edge of another such panel, locking is obtained in the direction perpendicular to the plane of the coupled panels. The distal end of the lip of the upper hook-shaped portion comprises a third sealing face; and the proximal end of the fourth edge comprises a fourth sealing face, wherein the third sealing face and the fourth sealing face are configured so that in the coupled state of such a panel with its third edge against the fourth edge of another such panel, the third sealing face of said panel comes into contact with or abuts closely to the fourth sealing face of the other such panel. The method comprises the step in which, in a first milling operation on the third edge, material of the panel is milled away on the decorative side of the third edge. The method comprises the step in which, in a second milling operation on the third edge, the third sealing face acquires its final form and dimension. The method is characterized in that, in the second milling operation on the third edge, everywhere perpendicular to the final third sealing face, at most 0.3 mm of material is milled away; and preferably at most 0.2 mm.

The first milling operation on the third edge allows an amount of material on the third edge to be milled away without the final form and dimension of the third sealing face being established. In a subsequent second milling operation on the third edge, the third sealing face acquires its final dimension and form. In the case of delicate panels, particularly with panels that comprise a flexible layer above the substrate and underneath the decorative finish, there is a risk, owing to the compressive forces perpendicular to the third edge during milling, of a displacement occurring in the panel. This would mean that the third sealing face would not be milled with the required close tolerance. To avoid this, in the second milling operation on the third edge, which establishes the final form and dimension of the third sealing face, only a limited amount of material is removed. As a result, in this second milling operation on the third edge, the compressive forces perpendicular to the third edge remain limited, and the third sealing face can be milled with the required close tolerance.

In the second milling operation on the third edge, material is removed at places on the third edge where material had already been milled away in the first milling operation on the third edge.

A preferred embodiment of the third aspect of the invention is characterized in that, in the second milling operation on the third edge, a pressure shoe presses on the panel, wherein the pressure of the pressure shoe is at most 0.8 bar.

This embodiment ensures synergistically that the third sealing face can be milled correctly. If the panel comprises an elastic or flexible layer close to the decorative side, a high pressure of the pressure shoe in the milling operation may cause an indentation of the panel perpendicular to the panel. Such indentation may lead to incorrect milling of the third sealing face.

A preferred embodiment of the third aspect of the invention is characterized in that the first milling operation on the third edge is carried out in several milling operations.

Therefore the amount of material that is removed per milling operation is limited. This makes it possible to limit the pressure perpendicular to the milled edge, so that milling is more accurate.

A preferred embodiment of the third aspect of the invention is characterized in that the first milling operation on the third edge and/or the second milling operation on the third edge are carried out progressively in the direction of advance of the panels through the continuous milling machine.

This embodiment ensures synergistically that the third sealing face can be produced to close tolerances, because in this way the compressive force perpendicular to the milled edge and in the plane of the panels in the milling operations is limited.

The fourth aspect of the invention relates to a method for milling, on a continuous milling machine, coupling parts on a pair of opposite edges of a decorative panel; optionally a method such as in any embodiment of the first aspect and/or of the second aspect of the invention and/or of the third aspect of the invention, wherein the panel comprises a substrate and a decorative layer, wherein the panel has a decorative side, which is the side of the panel where the decorative layer is located; and an underside, which is the side of the panel opposite the decorative layer, wherein the pair of opposite edges comprises a third edge and an opposite fourth edge, wherein in the method, a coupling part that comprises a downward directed upper hook-shaped portion is formed on the third edge, wherein the upper hook-shaped portion comprises a lip with a downward directed locking element that forms a male part; wherein in the method, a coupling part that comprises an upward directed lower hook-shaped portion is formed on the fourth edge, wherein the lower hook-shaped portion consists of a lip with an upward directed locking element that defines a female part in the form of a recess proximal thereto; wherein the coupling parts are configured for coupling together the third edge of such a panel to the fourth edge of another such panel; wherein on coupling the third edge of such a panel to the fourth edge of another such panel, the male part engages in the female part wherein locking is produced in the direction in the plane of the panels and perpendicular to the coupled edges; preferably wherein the coupling part on the third edge and the coupling part on the fourth edge comprise locking parts, so that on coupling the third edge of such a panel to the fourth edge of another such panel, locking is obtained in the direction perpendicular to the plane of the coupled panels. The distal end of the lip of the upper hook-shaped portion comprises a third sealing face; and the proximal end of the fourth edge comprises a fourth sealing face, wherein the third sealing face and the fourth sealing face are configured so that in the coupled state of such a panel with its third edge against the fourth edge of another such panel, the third sealing face of said panel comes into contact with or abuts closely to the fourth sealing face of the other such panel. The method comprises the step in which, in a first milling operation on the fourth edge, material of the panel is milled away on the decorative side of the fourth edge. The method comprises the step in which, in a second milling operation on the fourth edge, the fourth sealing face acquires its final form and dimension. The method is characterized in that, in the second milling operation on the fourth edge, everywhere perpendicular to the final fourth sealing face, at most 0.3 mm of material is milled away; and preferably at most 0.2 mm.

The first milling operation on the fourth edge allows an amount of material on the fourth edge to be milled away without the final form and dimension of the fourth sealing face being established. In a subsequent second milling operation on the fourth edge, the fourth sealing face acquires its final dimension and form. In the case of delicate panels, particularly with panels that comprise a flexible layer above the substrate and underneath the decorative finish, there is a risk, owing to the compressive forces perpendicular to the fourth edge during milling, of a displacement occurring in the panel. This would mean that the fourth sealing face would not be milled with the required close tolerance. To avoid this, in the second milling operation on the fourth edge, which establishes the final form and dimension of the third sealing face, only a limited amount of material is removed. Therefore in this second milling operation on the fourth edge, the compressive forces perpendicular to the fourth edge remain limited, and the fourth sealing face can be milled with the required close tolerance.

In the second milling operation on the fourth edge, material is removed at places on the fourth edge where material had already been milled away in the first milling operation on the fourth edge.

A preferred embodiment of the fourth aspect of the invention is characterized in that, in the second milling operation on the fourth edge, a pressure shoe presses on the panel, wherein the pressure of the pressure shoe is at most 0.8 bar.

This embodiment ensures synergistically that the fourth sealing face can be milled correctly. If the panel comprises an elastic or flexible layer close to the decorative side, a high pressure of the pressure shoe in the milling operation may cause an indentation of the panel perpendicular to the panel. Such indentation may lead to incorrect milling of the fourth sealing face.

A preferred embodiment of the fourth aspect of the invention is characterized in that the first milling operation on the fourth edge is carried out in several milling operations.

Therefore the amount of material that is removed per milling operation is limited. This makes it possible to limit the pressure perpendicular to the milled edge, so that milling is more accurate.

A preferred embodiment of the third aspect of the invention is characterized in that the first milling operation on the fourth edge and/or the second milling operation on the fourth edge are carried out progressively in the direction of advance of the panels through the continuous milling machine.

This embodiment ensures synergistically that the fourth sealing face can be produced to close tolerances, because in this way the compressive force perpendicular to the milled edge and in the plane of the panels in the milling operations is limited.

An embodiment of the third aspect of the invention and of the fourth aspect of the invention is characterized in that the second milling operation on the third edge and the second milling operation on the fourth edge are carried out simultaneously in the continuous milling machine and directly opposite each other relative to the panel.

The carrying out of milling operations simultaneously and directly opposite each other on the third edge and on the fourth edge allows forces exerted on the edges by the milling operations to be compensated, especially if these do not differ from each other too much and/or remain limited on both edges.

An embodiment according to the first aspect of the invention and/or according to the second aspect of the invention and/or according to the third aspect of the invention and/or according to the fourth aspect of the invention is characterized in that the panel is led through the continuous milling line with the decorative side directed downwards and supported.

An embodiment according to the first aspect of the invention and/or according to the second aspect of the invention and/or according to the third aspect of the invention and/or according to the fourth aspect of the invention is characterized in that each milling operation carried out in the method is carried out progressively in the direction of advance of the panels through the continuous milling machine.

As a result, the forces are limited transversely to the edge where milling takes place.

Preferred embodiments are characterized in that the substrate comprises polyvinyl chloride (PVC), and optionally calcium carbonate (CaCO₃) as filler.

A preferred embodiment of the invention is characterized in that the substrate comprises polyvinyl chloride (PVC), and calcium carbonate (CaCO₃) as filler, wherein the calcium carbonate (CaCO₃) has a concentration between 60.0 and 80.0 wt % and the polyvinyl chloride (PVC) has a concentration between 20.0 and 40.0 wt % of the substrate.

A preferred embodiment of the invention is characterized in that the substrate comprises or consists of a mineral board; preferably wherein this mineral board is selected from a magnesium oxide board, a plasterboard or a cement-bound board.

A preferred embodiment of the invention is characterized in that the substrate comprises or consists of a wood-based layer, preferably wherein this wood-based layer is selected from a wood fibre board (more preferably an MDF or HDF board), a chipboard, or consists of parallel laths.

Preferred embodiments of any aspect of the invention are characterized in that the decorative panel comprises an intermediate layer and a top layer, wherein the top layer comprises the decorative layer, wherein the intermediate layer is located between the substrate and the top layer, wherein the intermediate layer has at least one, and preferably several, of the following properties:
the intermediate layer has a Shore A hardness that is 10 units lower than the Shore A hardness of the substrate. In the context of the present invention, the term “Shore A hardness” preferably indicates the hardness of the intermediate layer as determined with a Shore durometer of type A. The methodology for determining the Shore A hardness, as well as the specific requirements that are stipulated for a Shore durometer of type A, are defined in ASTM standard D2240, particularly ASTM standard D2240-15R21,
the intermediate layer has an elastic modulus that is at least 10.0% lower than the elastic modulus of the substrate. A suitable method for measuring the elastic modulus is ASTM standard E111-17;
the intermediate layer comprises a material with a substantially open cell structure;
the intermediate layer comprises a foamed thermoplastic material or a foamed thermosetting material, preferably a flexible foamed material.

These intermediate layers ensure that the decorative panels are sound-absorbing. This is especially important for decorative panels used as floor panels. This intermediate layer may have a thickness between 0.5 and 2 mm, for example a thickness between 1 and 1.5 mm.

An embodiment is characterized in that the intermediate layer comprises a foamed thermoplastic material or a foamed thermosetting material, wherein the foamed thermoplastic material or the foamed thermosetting material has an empty cell volume between 10.0 and 80.0 vol %.

These embodiments result in decorative panels that have good sound-absorbing properties when used as floor panels.

An embodiment is characterized in that the intermediate layer comprises a foamed thermoplastic material or a foamed thermosetting material, wherein the foamed material is selected from the group of ethylene vinyl acetate (EVA), irradiation crosslinked polyethylene (IXPE), irradiation crosslinked polypropylene (IXPP), expanded polyethylene (EPE), expanded polyethylene copolymer (EPC), polypropylene (PP), polyvinyl chloride (PVC), PVC plastisol, polyurethane or combinations thereof. Most preferably, the aforementioned foamed thermoplastic material is ethylene vinyl acetate (EVA).

According to a further or another embodiment, the aforementioned foamed thermoplastic material has a density that is between 100 and 200 kg/m³, preferably between 100 and 150 kg/m³, more preferably between 120 and 140 kg/m³. With increasing preference, the aforementioned densities are extremely advantageous in providing improved sound-absorbing properties and/or improved walking comfort.

These embodiments result in decorative panels that have good sound-absorbing properties when used as floor panels.

Preferably the decorative panel comprises a secondary substrate layer, wherein the intermediate layer is located between the substrate and the secondary substrate layer, and wherein the top layer is applied on the secondary substrate layer; preferably wherein the secondary substrate layer has a thickness of more than 2.0 mm. Preferably the secondary substrate layer has a thickness of at least 2.1 mm, 2.2 mm, 2.3 mm, 2.4 mm or 2.5 mm. The thickness of the secondary substrate layer may also be less than 2.0 mm and may for example be between 0.5 and 1 mm. The secondary substrate layer may be thinner than the intermediate layer. The secondary substrate layer may be thicker than the intermediate layer. The thickness of the secondary substrate layer may be almost the same as the thickness of the intermediate layer. In particular, it is possible that the secondary substrate layer has a thickness that is between 0.5 and 2.0 mm, preferably between 0.5 and 1.5 mm, more preferably between 0.5 and 1.0 mm, most preferably between 0.5 and 0.8 mm. A secondary substrate layer with a small thickness according to the present embodiment is particularly advantageous if it is combined with a high filler content. In particular, it is possible that the secondary substrate layer comprises calcium carbonate (CaCO₃) at a concentration between 60 and 80 wt % and comprises polyvinyl chloride (PVC) at a concentration between 20 and 40 wt %, wherein the secondary substrate layer has a thickness between 0.5 and 2.0 mm, preferably between 0.5 and 1.5 mm, more preferably between 0.5 and 1.0 mm, most preferably between 0.5 and 0.8 mm.

These embodiments offer various advantages. The secondary substrate layer provides better durability of the panel in normal use and against impact loading. The secondary substrate layer also provides better stabilization of the panel during the milling operations on the edges of the panel to form the coupling means. This makes it easier to produce coupling means to close tolerances.

According to a further or another embodiment, the thickness of the secondary substrate layer and the thickness of the intermediate layer are in proportion to one another according to a ratio that is between 10:10 and 2:10, preferably between 10:10 and 3:10, more preferably between 10:10 and 4:10. In the embodiment in question, an optimum balance is obtained between sound-absorbing properties, walking comfort and strength and/or stability of the panel. Most preferably, the thickness of the secondary substrate layer and the thickness of the intermediate layer are in proportion to one another according to a ratio that is between 8:10 and 4:10.

According to a practical embodiment, it is possible that the intermediate layer has a thickness between 0.5 and 2.0 mm, preferably between 0.7 and 1.8 mm, more preferably between 0.9 and 1.6 mm, for example such as 1.0 mm or 1.5 mm.

A preferred embodiment is characterized in that the intermediate layer has a Shore A hardness that is 10 units lower than the Shore A hardness of the secondary substrate layer; and/or in that the intermediate layer has an elastic modulus that is at least 10.0% lower than the elastic modulus of the secondary substrate layer.

A preferred embodiment of the invention is characterized in that the secondary substrate layer comprises polyvinyl chloride (PVC).

More preferably, the secondary substrate layer comprises plasticizers in an amount of less than 15 phr (parts per hundred resin), preferably of less than 10 phr, more preferably of less than 5 phr.

These embodiments provide a secondary substrate layer that endows the panel with sufficient stability.

A preferred embodiment of the invention is characterized in that the secondary substrate layer is configured to increase the stiffness of the panel, preferably wherein the secondary substrate layer comprises a reinforcing layer and/or wherein the secondary substrate layer comprises calcium carbonate (CaCO₃) as filler.

A preferred embodiment of the invention is characterized in that the secondary substrate layer comprises calcium carbonate (CaCO₃) as filler, wherein the calcium carbonate (CaCO₃) has a concentration between 60.0 and 80.0 wt % and the polyvinyl chloride (PVC) has a concentration between 20.0 and 40.0 wt % of the secondary substrate layer.

A preferred embodiment of the invention is characterized in that, in a coupled state between two adjacent panels, the intermediate layers of the adjacent panels are pressed against each other, wherein a seal forms along the coupled edges of the adjacent panels. Said seal may be formed between coupled first and second edges; and/or between coupled third and fourth edges. It is preferable to provide the coupling parts in such a way that said seal is formed both between coupled first and second edges and between coupled third and fourth edges.

A preferred embodiment of the invention is characterized in that, in a coupled state between two adjacent panels, the intermediate layers of the adjacent panels do not touch each other, wherein a space is formed between the intermediate layers on the coupled edges of the coupled panels.

One embodiment of any aspect of the invention is characterized in that on at least one—and preferably on both—of the opposite edges provided with coupling parts, the edge is formed in such a way that the intermediate layer comprises a bulge on the edge of the panel. This may be produced by means of suitable milling operations during milling of the coupling parts on the respective edges of the panel. These embodiments have the advantage that in a coupled state between two adjacent panels, the intermediate layers of the adjacent panels are pressed against each other, wherein a seal forms along the coupled edges of the adjacent panels. Said seal may be formed between coupled first and second edges; and/or between coupled third and fourth edges. It is preferable to provide the coupling parts in such a way that said seal is formed both between coupled first and second edges and between coupled third and fourth edges.

An embodiment of any aspect of the invention is characterized in that on at least one—and preferably on both—of the opposite edges provided with coupling parts, the edge is formed in such a way that the edge of the intermediate layer is located in a recess. This may be achieved by suitable milling operations during milling of the coupling parts on the respective edges of the panel. In these embodiments, in the coupled state between two adjacent panels, the intermediate layers of the adjacent panels do not touch each other, and a space is formed between the intermediate layers on the coupled edges of the coupled panels.

An embodiment is characterized in that on one of the opposite edges provided with coupling parts, the edge is formed in such a way that the intermediate layer comprises a bulge on the edge of the panel, and in that on the opposite edge, the edge is formed in such a way that the edge of the intermediate layer is located in a recess. These embodiments have the advantage that on coupling the panels on this pair of opposite edges, the bulge can be received in the recess of the opposite edge, so that sealing of the panels thus coupled is obtained.

An embodiment of any aspect of the invention is characterized in that the substrate is at least 3 mm thick, and preferably is less than 5 mm thick.

A preferred embodiment of the invention is characterized in that the underside of the panel comprises a damping layer. Preferably the damping layer comprises a layer selected from ethylene vinyl acetate (EVA), irradiation crosslinked polyethylene (IXPE), irradiation crosslinked polypropylene (IXPP), expanded polyethylene (EPE), expanded polyethylene copolymer (EPC), polypropylene (PP), polyvinyl chloride (PVC), PVC plastisol, and polyurethane.

The use of ordinal numbers first, second, third, fourth . . . for the milling operations does not refer to the order or the sequence of these milling operations; these ordinal numbers are used for distinguishing the milling operations from each other.

For better illustration of the features of the invention, some preferred embodiments are described hereunder, as examples without any limiting character, referring to the appended drawings, in which:

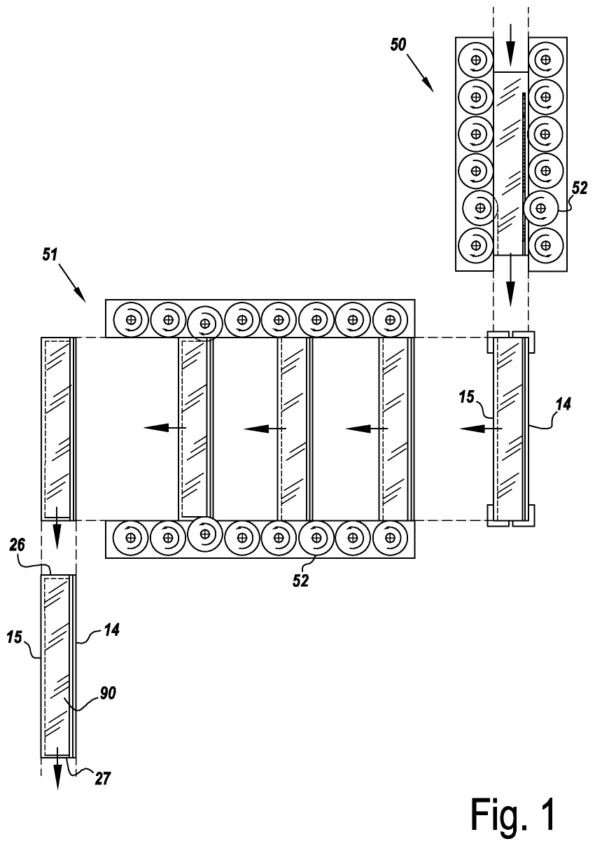

FIG. 1 shows a machine arrangement such as may be used in the method of the invention;

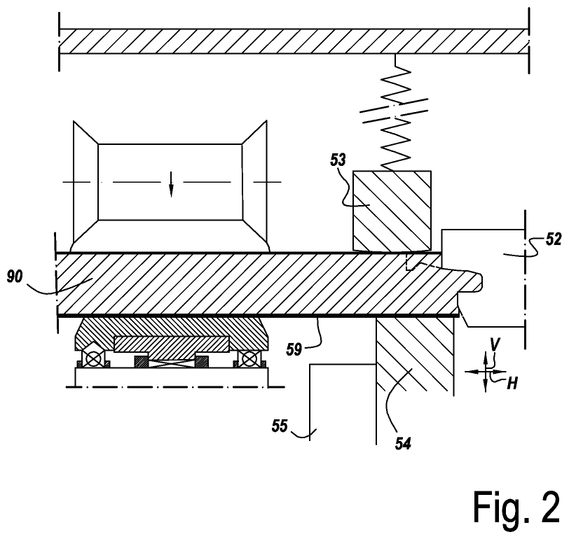

FIG. 2 illustrates the use of pressure shoes in an embodiment of the method of the invention;

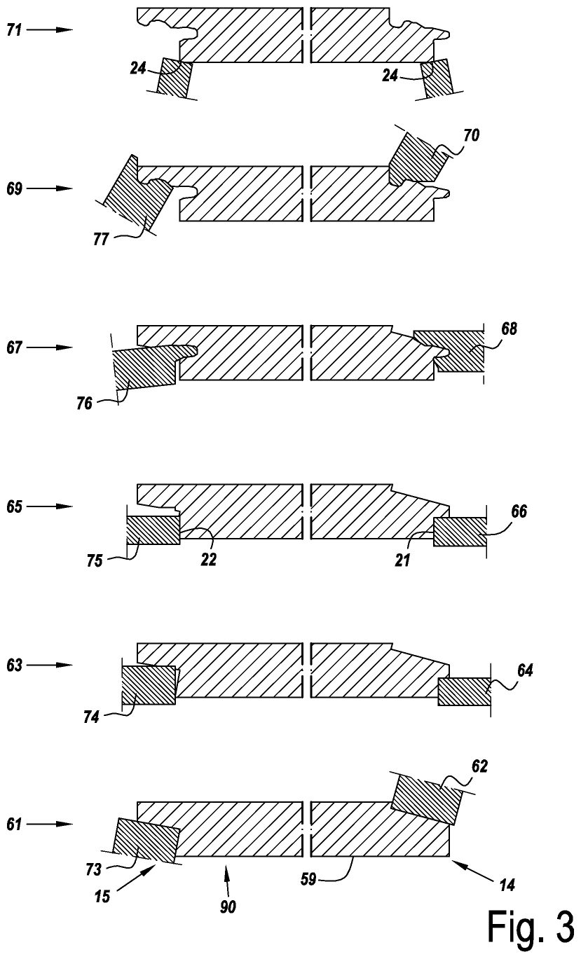

FIG. 3 shows an example of a sequence of milling operations on the first edge and on the second edge of a decorative panel according to an example of the method according to the invention;

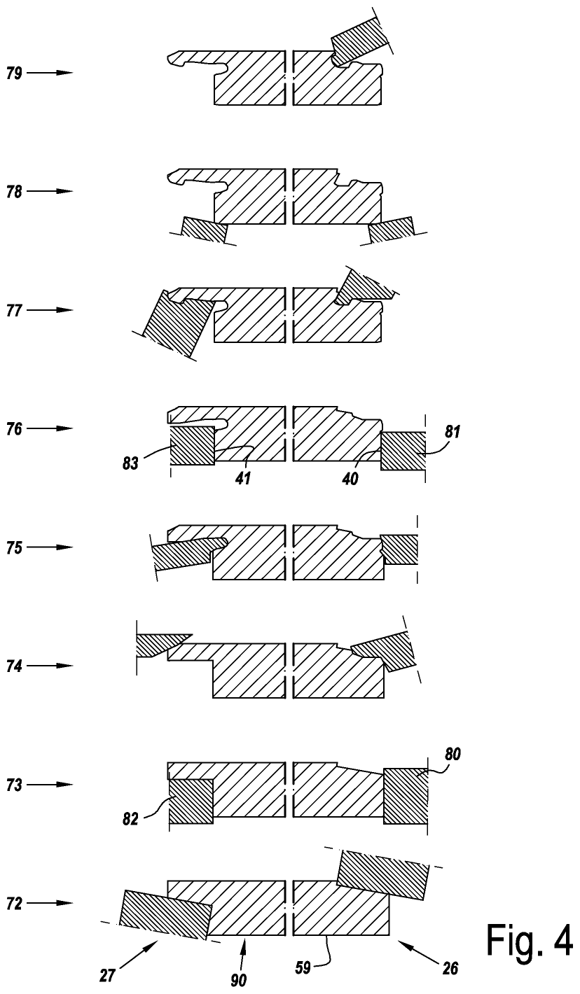

FIG. 4 shows an example of a sequence of milling operations on the third edge and on the fourth edge of a decorative panel according to an example of the method according to the invention;

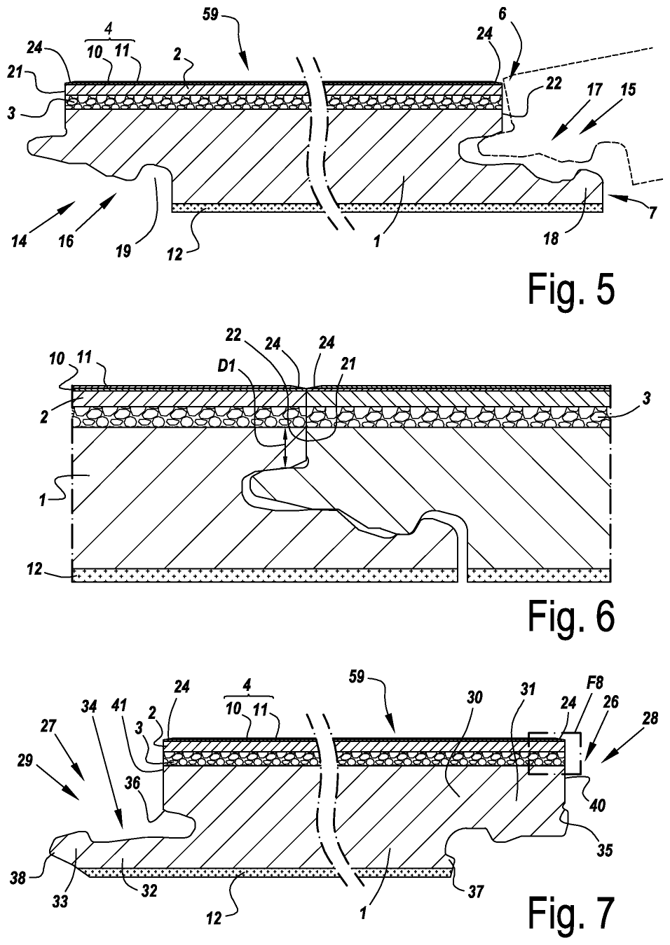

FIG. 5 shows an example of the first edge and the second edge of a decorative panel that can be made by the method of the invention;

FIG. 6 shows two decorative panels such as in FIG. 5 in the coupled state;

FIG. 7 illustrates an example of the third edge and the fourth edge of a decorative panel that can be made by the method of the invention;

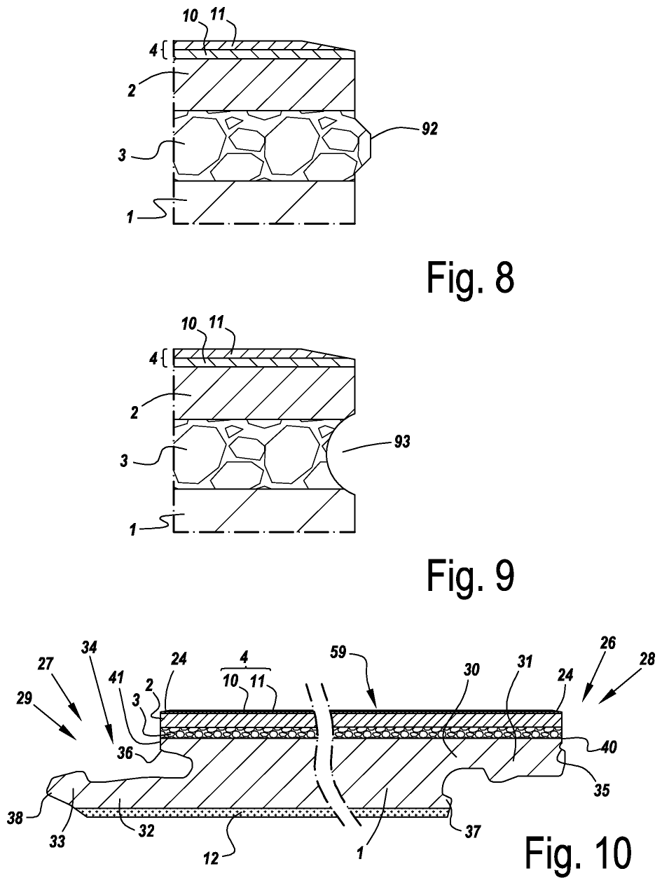

FIGS. 8 and 9 show specific configurations of the edges of decorative panels that can be made by the method according to the invention;

FIG. 10 shows another example of the first edge and the second edge of a decorative panel that can be made by the method of the invention.

FIG. 1 shows a machine arrangement such as may be used in the method of the invention for creating coupling parts on rectangular decorative panels. By means of two continuous milling machines 50, 51, coupling parts can be milled on the four edges 14, 15, 26, 27 of the panel 90. In the first continuous milling machine 50, coupling parts are milled on the first edge 14 and on the second edge 15. These edges 14, 15 are directly opposite each other and form the long edges. Next, in the second continuous milling machine 51, coupling parts are milled on the third edge 26 and the fourth edge 27. These edges 26, 27 are directly opposite each other and form the short edges.

The decorative panels are led continuously through the continuous milling lines 50, 51 with the decorative side of the panels directed downwards and supported.

Preferably the milling operations 52 in the method according to the invention are carried out in such a way that the milling operations are carried out progressively in the direction of advance of the panels through the continuous milling machine. This is shown in FIG. 1.

FIG. 2 illustrates the use of pressure shoes 53 in an embodiment of the method of the invention. FIG. 2 illustrates specifically a detail of a milling operation 52 on the edge of a panel 90 that is led through a continuous milling machine. The edge that is processed by the milling operation is supported by a sliding shoe 55 fastened on the machine bed 55 of the continuous milling machine, whereas a pressure shoe 53 presses the edge that is processed by the milling operation against the sliding shoe.

Preferably, in the methods according to the invention, the pressure of the pressure shoe 53, at least in the most critical milling operations, is limited to less than 0.8 bar.

FIG. 3 shows an example of a sequence of milling operations on the first edge 14 and on the second edge 15 of decorative panels 90 according to an example of methods according to the invention. The decorative panels 90 are led through a continuous milling machine (for example such as in FIG. 1) with the decorative side 59 of the panels directed downwards and supported. On the first pair of opposite edges 14, 15, more specifically on a first edge 14 and on an opposite second edge 15, coupling parts are milled on the decorative panel 90. The decorative panels comprise a substrate and a decorative layer. The decorative side 59 of the panel is the side of the decorative panel where the decorative layer is located. The underside of the panel is the side of the decorative panel opposite the decorative layer. The result of the method illustrated in FIG. 3 may be a panel such as shown in FIG. 5.

The coupling parts on the first edge and on the second edge that are formed in the method are configured for coupling together the first edge of such a panel to the second edge of another such panel. Preferably the coupling parts comprise locking parts for locking such a panel coupled with its first edge to the second edge of another such panel in the direction perpendicular to the plane of the coupled panels and/or in the direction perpendicular to the coupled edges and in the plane of the panels.

A coupling part in the form of a tongue is milled on the first edge 14, and a coupling part in the form of a groove is milled on the second edge 15. The groove is delimited by a lower lip and an upper lip. The upper lip is located on the decorative side 59. The decorative side of the panel comprises a first sealing face 21 on the first edge. The distal end of the upper lip comprises a second sealing face 22. The first sealing face and the second sealing face are configured so that in the coupled state of such a panel with its first edge against the second edge of another such panel, the first sealing face of said panel comes into contact with or abuts closely to the second sealing face of the other such panel.

In a first step 61, a fourth tongue edge milling operation 62 is carried out, wherein material is milled away on the underside of the first edge. A rough shape is formed thereby on the underside of the panel of at least one distal end of the tongue. In FIG. 3, this fourth tongue edge milling operation is carried out in one step. It is, however, also possible to carry out this fourth tongue edge milling operation in at least two milling steps.

In a second step 63, in a first tongue edge milling operation 64, material of the panel is milled away on the first edge 14 on the decorative side where the tongue will be formed. In this way, on the decorative side, a rough shape is formed of at least one part of the tongue to be milled in the method. In FIG. 3, this first tongue edge milling operation is carried out in one step. It is, however, also possible to carry out this first tongue edge milling operation in at least two milling steps.

In the third step 65, the first sealing face 21 acquires its final form and dimension by means of a second tongue edge milling operation 66. In this second tongue edge milling operation, everywhere perpendicular to the final first sealing face 21, at most 0.3 mm of material is milled away; and preferably at most 0.2 mm.

In a fourth step 67, a third tongue edge milling operation 68 is carried out, wherein the side of the tongue directed towards the decorative side acquires its final form and dimension. In the third tongue edge milling operation, where the tongue, in the third tongue edge milling operation, acquires its final form and dimension on the side directed towards the decorative side, everywhere locally perpendicular to this final dimension of the tongue, at most 0.3 mm of material is milled away, and preferably at most 0.2 mm.

The third tongue edge milling operation 68 of the embodiment shown in FIG. 3 provides the tongue on the underside of the panel at least over a distal part of the tongue with its final form and dimension, wherein, where the tongue acquires its final form and dimension in the third tongue edge milling operation on the underside of the panel, everywhere in the third tongue edge milling operation in the direction locally perpendicular to this final dimension of the tongue, at most 0.3 mm of material is milled away, and preferably at most 0.2 mm.

In a fifth step 69, in a fifth tongue edge milling operation 70, a recess is milled on the underside of the tongue, wherein the recess is configured to interact with a projection on the lower lip for locking in the plane of the decorative panels and perpendicular to the coupled edges of a decorative panel of this kind coupled with its first edge to the second edge of another such decorative panel.

In a sixth step 71, a chamfer is produced in a milling operation on the first edge. The forming of chamfers is optional in the method of the invention.

In the first step 61, in a fourth groove edge milling operation 73, material is milled away on the second edge 15. In FIG. 3, this fourth groove edge milling operation is carried out in one step. It is, however, also possible to carry out this fourth groove edge milling operation in at least two milling steps.

In the second step 63, in a first groove edge milling operation 74, material of the decorative panel is milled away on the second edge 15 on the decorative side where the groove will be formed. In this first groove edge milling operation 74, a rough shape is formed on the decorative side of at least one part of the profile to be milled on the second edge in the method. In FIG. 3, this first groove edge milling operation is carried out in one step. It is, however, also possible to carry out this first groove edge milling operation in at least two milling steps.

In the third step 65, the second sealing face 22 acquires its final form and dimension by means of a second groove edge milling operation 75, wherein in the second milling operation, everywhere perpendicular to the final second sealing face, at most 0.3 mm of material is milled away; and preferably at most 0.2 mm.

In the fourth step 67, in a third groove edge milling operation 76, at least part of the groove proximal to the upper lip is formed.

In the fifth step 69, at least one part of the upper side of the lower lip acquires its final form by means of a fifth groove edge milling operation 77. In the embodiment in FIG. 3, the distal end of the lower lip also acquires its final form in this fifth groove edge milling operation.

In the sixth step 71, a chamfer is produced in a milling operation on the second edge 15. The forming of chamfers is optional in the method of the invention.

The fourth tongue edge milling operation 62 and the fourth groove edge milling operation 73 are carried out simultaneously in the continuous milling machine and, relative to the decorative panel, directly opposite each other.

The first tongue edge milling operation 64 and the first groove edge milling operation 74 are carried out simultaneously in the continuous milling machine and, relative to the decorative panel, directly opposite each other.

The second tongue edge milling operation 66 and the second groove edge milling operation 75 are carried out simultaneously in the continuous milling machine and, relative to the decorative panel, directly opposite each other.

The third tongue edge milling operation 68 and the third groove edge milling operation 76 are carried out simultaneously in the continuous milling machine and, relative to the decorative panel, directly opposite each other.

The fifth tongue edge milling operation 70 and the fifth groove edge milling operation 69 are carried out simultaneously in the continuous milling machine and, relative to the decorative panel, directly opposite each other.

In the sixth step 71, the chamfers are formed in milling operations on the first edge 14 and on the second edge 15 simultaneously and directly opposite each other relative to the panel. The forming of chamfers is optional in the method of the invention.

FIG. 4 shows an example of a sequence of milling operations on the third edge 26 and on the fourth edge 27 of a decorative panel 90 according to an example of methods according to the invention. Panels 90 are led through a continuous milling machine (for example such as in FIG. 1) with the decorative side 59 of the panels directed downwards and supported. In this process, coupling parts are milled on a pair of opposite edges, more specifically a third edge 26 and an opposite fourth edge 27, of a decorative panel. The panel comprises a substrate and a decorative layer. The decorative side 59 of the panel is the side of the panel where the decorative layer is located; and an underside of the panel is the side of the panel opposite the decorative layer.

The coupling part that is formed on the third edge 26 in the example comprises a downward directed upper hook-shaped portion, wherein the upper hook-shaped portion comprises a lip with a downward directed locking element that forms a male part. The coupling part that is formed on the fourth edge 27 in the example comprises a coupling part that comprises an upward directed lower hook-shaped portion, wherein the lower hook-shaped portion consists of a lip with an upward directed locking element, which defines a female part in the form of a recess proximal thereto. These coupling parts are configured for coupling together the third edge of such a panel to the fourth edge of another such panel; wherein on coupling the third edge of such a panel to the fourth edge of another such panel, the male part engages in the female part wherein locking is achieved in the direction in the plane of the panels and perpendicular to the coupled edges. Preferably the coupling part on the third edge and the coupling part on the fourth edge comprise locking parts, so that on coupling the third edge of such a decorative panel to the fourth edge of another such decorative panel, locking is achieved in the direction perpendicular to the plane of the coupled decorative panels.

The distal end of the lip of the upper hook-shaped portion comprises a third sealing face 40. The proximal end of the fourth edge comprises a fourth sealing face 41. The third sealing face and the fourth sealing face are configured so that in the coupled state of said decorative panel with its third edge against the fourth edge of another such decorative panel, the third sealing face of said decorative panel comes into contact with or abuts closely to the fourth sealing face of the other such decorative panel.

In a series of successive steps 72, 73, 74, 75, 76, 77, 78, 79, these coupling parts are formed on the third edge 26 and on the fourth edge 27. In each of these successive steps, milling operations are carried out both on the third edge 26 and on the fourth edge 27. In this way, coupling parts may be obtained such as illustrated in the example shown in FIG. 7.

In the step indicated with reference number 73, in a first milling operation 80 on the third edge 26, material of the panel is milled away on the decorative side of the third edge. In the step indicated with reference number 76, in a second milling operation 81, the third sealing face 40 on the third edge acquires its final form and dimension. In this second milling operation, on the third edge, everywhere perpendicular to the final third sealing face, at most 0.3 mm of material is milled away; and preferably at most 0.2 mm. It is obvious that the first milling operation is carried out before the second milling operation. As in the embodiment shown in FIG. 4, it is quite possible that other milling operations are carried out on the third edge between the first milling operation 80 and the second milling operation 81.

In the second milling operation on the third edge, a pressure shoe presses on the panel on the third edge, wherein preferably the pressure of this pressure shoe is at most 0.8 bar.

The first milling operation on the third edge may be carried out in several milling operations.

In the step indicated with reference number 73, in a first milling operation 82 on the fourth edge 27, material of the panel is milled away on the decorative side of the fourth edge. In the step indicated with reference number 76, in a second milling operation 83 on the fourth edge 27, the fourth sealing face 41 acquires its final form and dimension. In this second milling operation, on the fourth edge everywhere perpendicular to the final fourth sealing face, at most 0.3 mm of material is milled away; and preferably at most 0.2 mm.

In the second milling operation on the fourth edge, a pressure shoe presses on the panel on the fourth edge, wherein preferably the pressure of this pressure shoe is at most 0.8 bar.

The first milling operation on the fourth edge may be carried out in several milling operations.

The second milling operation 81 on the third edge and the second milling operation 83 on the fourth edge are carried out simultaneously in the continuous milling machine and, relative to the decorative panel, directly opposite each other.

FIG. 5 shows an example of the first edge 14 and the second edge 15 of a rectangular decorative panel 90 that can be made by the method of the invention. FIG. 6 shows two panels such as in FIG. 5 coupled to their first pair of opposite edges 14, 15. FIG. 10 shows another example of the first edge 14 and of the second edge 15 of a rectangular decorative panel 90 that can be made by the method of the invention. It can be seen from FIG. 10 that the intermediate layer 3 may also be thinner than the secondary substrate layer 2. Thus, the intermediate layer 3 for example may only be half as thick as the secondary substrate layer 2, or more explicitly, the thickness of the intermediate layer 3 may be only 25%, or even only 10% of the thickness of the secondary substrate layer 2.

The panels shown in FIGS. 5, 6 and 10 each comprise a substrate 1, a secondary substrate layer 2, an intermediate layer 3, and a top layer 4. The top layer 4 comprises a decorative layer 10 and a wearing layer 11. The decorative side 59 of the panel is the side of the panel where the decorative layer 10 is located. The underside of the panel comprises a damping layer 12. The intermediate layer 3 is located between the substrate 1 and the secondary substrate layer 2. The secondary substrate layer 2 may have a thickness of at least 2 mm, but a thinner substrate layer 2 is also possible. The top layer 4 is applied on the secondary substrate layer 2. The intermediate layer 3 preferably has at least one of the following properties:
the intermediate layer has a Shore A hardness that is 10 units lower than the Shore A hardness of the substrate;
   the intermediate layer has an elastic modulus that is at least 10.0% lower than the elastic modulus of the substrate;
   the intermediate layer comprises a material with a substantially open cell structure;
   the intermediate layer comprises a foamed thermoplastic material or a foamed thermosetting material, preferably a flexible foamed material;
the intermediate layer has a thickness between 0.5 and 2 mm.

Said intermediate layer 3 provides sound-absorbing properties of the panel. Depending on the embodiment, the intermediate layer 3 may be thinner than, thicker than or may have the same thickness as the secondary substrate layer 2.

Each decorative panel has a first edge 14 and an opposite second edge 15. The first edge 14 and the second edge 15 comprise coupling parts 16, 17 for coupling together the first edge of such a panel to the second edge of another such panel. FIG. 6 shows two such decorative panels coupled on their first pair of opposite edges 14, 15.

The coupling part 16 on the first edge 14 is made in the form of a tongue 8. The coupling part 17 on the second edge 15 is made in the form of a groove 5, delimited by a lower lip 7 and an upper lip 6. The upper lip 6 is located on the decorative side of the panel. The lower lip 7 extends farther from the second edge 15 than the upper lip 6. The tongue 8 and the groove 5 provide, in the coupled state, locking in the direction perpendicular to the plane of the coupled panels. The lower lip 6 comprises a vertical locking part 18, which together with a recess 19 on the underside of the tongue 8 provides, in the coupled state, locking perpendicular to the coupled edges 14, 15 and in the plane of the coupled panels.

The intermediate layer 3 is present over its entire thickness in the upper lip 6. The minimum thickness D1 of the substrate 1 in the upper lip 6 and under the intermediate layer 3, in the section where in the coupled state of a panel with its first edge 14 against the second edge 15 of another such panel, the tongue 8 of the first panel comes into contact with the upper lip 6 of the second panel, is preferably at least 0.4 mm, and more preferably at least 0.5 mm and even more preferably at least 1 mm.

On the decorative side, the panel comprises a first sealing face 21 on the first edge 14. The distal end of the upper lip 6 comprises a second sealing face 22. The first sealing face 21 and the second sealing face 22 are configured so that in the coupled state of such a panel with its first edge 14 against the second edge 15 of another such panel, the first sealing face 21 of said panel comes into contact with or abuts closely to the second sealing face 22 of the other such panel.

The coupling parts 16, 17 on the first edge 14 and the second edge 15 of the decorative panel in FIG. 5 are configured so that the decorative panel can be coupled with its first edge 14 against the second edge 15 of another such decorative panel by means of a rolling motion and/or by means of a sliding motion substantially parallel to the plane of the decorative panels, wherein snapping occurs.

The decorative panel shown in FIG. 5 comprises a chamfer 24 on the first edge 14 and on the second edge 15. Such chamfers are optional in the context of the invention.

FIG. 7 shows an example of the third edge 26 and the opposite fourth edge 27 of a rectangular decorative panel that can be made by the method of the invention. This relates to the same decorative panel whose first edge 14 and second edge 15 are shown in FIG. 5. The same reference numbers thus have the same meaning.

The decorative panel comprises, on its the third edge 26, a coupling part 28 formed by a downward directed upper hook-shaped portion. This upper hook-shaped portion comprises a lip 30 with a downward directed locking element 31 that forms a male part. The panel comprises, on the fourth edge 27, a coupling part 29 formed by an upward directed lower hook-shaped portion.

This lower hook-shaped portion consists of a lip 32 with an upward directed locking element 33 that defines a female part in the form of a recess 34 proximal thereto. These coupling parts are configured for coupling together the third edge 26, 27 of such a decorative panel to the fourth edge of another such decorative panel; wherein on coupling the third edge 26 of such a decorative panel to the fourth edge 27 of another such decorative panel, the male part engages in the female part wherein locking is achieved in the direction in the plane of the panels and perpendicular to the coupled edges 26, 27.

The coupling parts 28, 29 on the third edge 26 and on the fourth edge 27 comprise a first pair of locking parts 35, 36, which together in the coupled state provide locking of the coupled decorative panels in the direction perpendicular to the coupled edges. The coupling parts 28, 29 on the third edge 26 and on the fourth edge 27 comprise a second pair of locking parts 37, 38, which together in the coupled state provide locking of the coupled decorative panels in the direction perpendicular to the coupled edges.

The distal end of the lip 30 of the upper hook-shaped portion comprises a third sealing face 40. The proximal end of the fourth edge 27 comprises a fourth sealing face 41. The third sealing face 40 and the fourth sealing face 41 are configured so that in the coupled state of such a decorative panel with its third edge 26 against the fourth edge 27 of another such decorative panel, the third sealing face 40 of said decorative panel comes into contact with or abuts closely to the fourth sealing face 41 of the other such decorative panel.

FIGS. 8 and 9 show in detail according to F8 in FIG. 7 specific configurations of the edges of decorative panels that can be made by the method according to the invention. In the embodiment in FIG. 7, the intermediate layer 3 on the two opposite edges 26, 27 ends in the same vertical plane as the top layer 4.

FIG. 8 shows an embodiment in which the intermediate layer 3 comprises a bulge 92 on the edge of the panel. This can be formed on both opposite edges, or only on one of the pair of opposite edges. This may be achieved by suitable milling operations during milling of the coupling parts on the respective edges of the panel. This embodiment has the advantage that in the coupled state between two adjacent panels, the intermediate layers of the adjacent panels are pressed against each other, this forms a seal along the coupled edges of the adjacent panels.

This may be done on one of the two pairs of opposite edges (either on the first pair of opposite edges or on the second pair of opposite edges) or on both pairs of opposite edges.

FIG. 9 shows an embodiment in which, on the edge of the panel, the edge of the intermediate layer 3 is located in a recess 93. This may be done on both opposite edges, or only on one of the pair of opposite edges. This may be achieved by suitable milling operations during milling of the coupling parts on the respective edges of the panel. In these embodiments, in the coupled state between two adjacent panels, the intermediate layers of the adjacent panels do not touch each other, and a space is formed between the intermediate layers on the coupled edges of the coupled panels.

This may be done on one of the two pairs of opposite edges (either on the first pair of opposite edges or on the second pair of opposite edges) or on both pairs of opposite edges.

It is also possible that on one edge of the panel, the intermediate layer has a bulge, and on the opposite edge, the edge of the intermediate layer is located in a recess on this edge.

The present invention is by no means limited to the embodiments described above. Many variants may be realized, without going outside the scope of the invention described.

1.-58. (canceled)

59. A method for milling, on a continuous milling machine, coupling parts on a pair of opposite edges of a decorative panel;
wherein the panel comprises a substrate and a decorative layer;
wherein the panel has a decorative side, which is the side of the panel where the decorative layer is located; and an underside, which is the side of the panel opposite the decorative layer;
wherein the pair of opposite edges comprises a first edge and an opposite second edge;
wherein the coupling parts are configured for coupling together the first edge of such a panel to the second edge of another such panel;
wherein the coupling parts comprise locking parts for locking such a panel coupled with its first edge to the second edge of another such panel in the direction perpendicular to the plane of the coupled panels and/or in the direction perpendicular to the coupled edges and in the plane of the panels;
wherein the method is carried out so that a coupling part in the form of a tongue is milled on the first edge and a coupling part in the form of a groove is milled on the second edge,
wherein the groove is delimited by a lower lip and an upper lip;
wherein the upper lip is on the decorative side;
wherein on the decorative side, the panel comprises a first sealing face on the first edge,
wherein the distal end of the upper lip comprises a second sealing face,
wherein the first sealing face and the second sealing face are configured so that in the coupled state of such a panel with its first edge against the second edge of another such panel, the first sealing face of said panel comes into contact with or abuts closely to the second sealing face of the other such panel;
wherein the method comprises the step in which, in a first tongue edge milling operation, material of the panel is milled away on the first edge on the decorative side where the tongue will be formed,
wherein, in this first tongue edge milling operation, on the decorative side a rough shape is formed of at least one part of the tongue to be milled in the method;
wherein the method comprises the step in which, in a second tongue edge milling operation, the first sealing face acquires its final form and dimension,
wherein, in the second tongue edge milling operation, everywhere perpendicular to the final first sealing face, at most 0.3 mm of material is milled away.

60. The method according to claim 59, wherein the method comprises the step in which, in a third tongue edge milling operation, the side of the tongue directed towards the decorative side acquires its final form and dimension,
wherein in the third tongue edge milling operation where the tongue, in the third tongue edge milling operation, acquires its final form and dimension on the side directed towards the decorative side, everywhere locally perpendicular to this final dimension of the tongue, at most 0.3 mm of material is milled away.

61. The method according to claim 60, wherein, in the third tongue edge milling operation, the tongue on the underside of the panel at least over a distal part of the tongue acquires its final form and dimension,
wherein, where the tongue acquires its final form and dimension in the third tongue edge milling operation on the underside of the panel, everywhere in the third tongue edge milling operation in the direction locally perpendicular to this final dimension of the tongue, at most 0.3 mm of material is milled away.

62. The method according to claim 60, wherein, in a fourth tongue edge milling operation, carried out at least before the third tongue edge milling operation, and before the first tongue edge milling operation, material is milled away on the underside on the first edge;
wherein a rough shape is formed on the underside of the panel of at least one distal end of the tongue.

63. The method according to claim 62, wherein, in a fifth tongue edge milling operation, a recess is milled on the underside of the tongue,
wherein the recess is configured to interact with a projection on the lower lip for locking, in the plane of the decorative panels and perpendicular to the coupled edges, a decorative panel of this kind coupled with its first edge to the second edge of another such decorative panel.

64. The method according to claim 59, wherein, in the second tongue edge milling operation, a pressure shoe presses on the panel, wherein the pressure of the pressure shoe is at most 0.8 bar.

65. The method according to claim 59, wherein, in the first tongue edge milling operation, a pressure shoe presses on the panel,
wherein the pressure of the pressure shoe is at most 0.8 bar.

66. The method according to claim 59, wherein the first tongue edge milling operation is carried out in at least two milling steps.

67. A method for milling, on a continuous milling machine, coupling parts on a pair of opposite edges of a decorative panel;
wherein the panel comprises a substrate and a decorative layer;
wherein the panel has a decorative side, which is the side of the panel where the decorative layer is located; and an underside, which is the side of the panel opposite the decorative layer;
wherein the pair of opposite edges comprises a first edge and an opposite second edge;
wherein the coupling parts are configured for coupling together the first edge of such a panel to the second edge of another such panel;
wherein the coupling parts comprise locking parts for locking such a panel coupled with its first edge to the second edge of another such panel in the direction perpendicular to the plane of the coupled panels and/or in the direction perpendicular to the coupled edges and in the plane of the panels;
wherein the method is carried out so that a coupling part in the form of a tongue is milled on the first edge and a coupling part in the form of a groove is milled on the second edge,
wherein the groove is delimited by a lower lip and an upper lip;
wherein the upper lip is on the decorative side;
wherein on the decorative side, the panel comprises a first sealing face on the first edge,
wherein the distal end of the upper lip comprises a second sealing face, wherein the first sealing face and the second sealing face are configured so that in the coupled state of such a panel with its first edge against the second edge of another such panel, the first sealing face of said panel comes into contact with or abuts closely to the second sealing face of the other such panel;
wherein the method comprises the step in which, in a first groove edge milling operation, material of the panel is milled away on the second edge on the decorative side where the groove will be formed,
wherein in this first groove edge milling operation, on the decorative side, a rough shape is formed of at least one part of the profile to be milled on the second edge in the method;
wherein the method comprises the step in which, in a second groove edge milling operation, the second sealing face acquires its final form and dimension,
wherein in the second groove edge milling operation, everywhere perpendicular to the final second sealing face, at most 0.3 mm of material is milled away.

68. The method according to claim 67, wherein the method comprises the step in which, in a third groove edge milling operation, at least the part of the groove proximal to the upper lip is formed.

69. The method according to claim 68, wherein, in a fourth groove edge milling operation, carried out at least before the third milling operation; and before the first groove edge milling operation; material is milled away on the second edge.

70. The method according to claim 69, wherein, in a fifth groove edge milling operation, at least a part of the upper side of the lower lip acquires its final form, the distal end of the lower lip also acquires its final form in this fifth groove edge milling operation.

71. The method according to claim 67, wherein, in the second groove edge milling operation, a pressure shoe presses on the panel,
wherein the pressure of the pressure shoe is at most 0.8 bar.

72. The method according to claim 67, wherein, in the first groove edge milling operation, a pressure shoe presses on the panel,
wherein the pressure of the pressure shoe is at most 0.8 bar.

73. The method according to claim 67, wherein the first groove edge milling operation is carried out in at least two milling steps.

74. The method according to claim 59, wherein the decorative panel comprises an intermediate layer and a top layer,
wherein the top layer comprises the decorative layer,
wherein the intermediate layer is located between the substrate and the top layer,
wherein the intermediate layer is located over its entire thickness in the upper lip;
wherein the minimum thickness of the substrate in the upper lip and under the intermediate layer, in the section where, in the coupled state of a panel with its first edge against the second edge of another such panel, the tongue of the first panel comes into contact with the upper lip of the second panel, is at least 0.4 mm.

75. A method for milling, on a continuous milling machine, coupling parts on a pair of opposite edges of a decorative panel;
wherein the panel comprises a substrate and a decorative layer;
wherein the panel has a decorative side, which is the side of the panel where the decorative layer is located; and an underside, which is the side of the panel opposite the decorative layer;
wherein the pair of opposite edges comprises a third edge and an opposite fourth edge;
wherein in the method, a coupling part that comprises a downward directed upper hook-shaped portion is formed on the third edge,
wherein the upper hook-shaped portion comprises a lip with a downward directed locking element that forms a male part;
wherein in the method, a coupling part that comprises an upward directed lower hook-shaped portion is formed on the fourth edge,
wherein the lower hook-shaped portion consists of a lip with an upward directed locking element that defines a female part in the form of a recess proximal thereto;
wherein the coupling parts are configured for coupling together the third edge of such a panel to the fourth edge of another such panel;
wherein on coupling the third edge of such a panel to the fourth edge of another such panel, the male part engages in the female part wherein locking is produced in the direction in the plane of the panels and perpendicular to the coupled edges;
wherein the coupling part on the third edge and the coupling part on the fourth edge comprise locking parts, so that on coupling the third edge of such a panel to the fourth edge of another such panel, locking is obtained in the direction perpendicular to the plane of the coupled panels;
wherein the distal end of the lip of the upper hook-shaped portion comprises a third sealing face,
wherein the proximal end of the fourth edge comprises a fourth sealing face;
wherein the third sealing face and the fourth sealing face are configured so that in the coupled state of such a panel with its third edge against the fourth edge of another such panel, the third sealing face of said panel comes into contact with or abuts closely to the fourth sealing face of the other such panel;
wherein the method comprises the step in which, in a first milling operation on the third edge, material of the panel is milled away on the decorative side of the third edge;
wherein the method comprises the step in which, in a second milling operation on the third edge, the third sealing face acquires its final form and dimension,
wherein, in the second milling operation on the third edge, everywhere perpendicular to the final third sealing face, at most 0.3 mm of material is milled away.

76. The method according to claim 75, wherein, in the second milling operation on the third edge, a pressure shoe presses on the panel, wherein the pressure of the pressure shoe is at most 0.8 bar.

77. The method according to claim 59, wherein the decorative panel comprises an intermediate layer and a top layer,
wherein the top layer comprises the decorative layer,
wherein the intermediate layer is located between the substrate and the top layer, wherein the intermediate layer comprises a foamed thermoplastic material or a foamed thermosetting material.

78. The method according to claim 77, wherein on one of the opposite edges provided with coupling parts, the edge is formed in such a way that the intermediate layer comprises a bulge on the edge of the panel; and in that the opposite edge is formed in such a way that the edge of the intermediate layer is located in a recess.
